(19) United States
(12) Patent Application Publication
(10) Pub. No.: US 2007/0127169 A1
(43) Pub. Date: Jun. 7, 2007

(54) Integrated circuit with configurable bypass capacitance

(75) Inventor: Huy Nguyen, San Jose, CA (US)

Correspondence Address: SILICON EDGE LAW GROUP, LLP, 6601 KOLL CENTER PARKWAY, SUITE 245, PLEASANTON, CA, 94566, US

(73) Assignee: Rambus, Inc.

(21) Appl. No.: 11/299,052

(22) Filed: Dec. 7, 2005

(51) Int. Cl. H01G 2/12

(52) U.S. Cl. 361/15

(57) ABSTRACT

An integrated-circuit die includes a bypass capacitance shared between two or more circuit blocks. The bypass capacitance is selectively connected to whichever of the circuit blocks is active (e.g., to a transmitting block while a receiving block is off or in a standby mode). Some embodiments include bypass select logic that can be used to customize the bypass resistance and capacitance on a chip-wide or circuit-specific basis.

### FIELD

The subject matter disclosed herein relates generally to the field of communications, and more particularly to high speed electronic signaling within and between integrated circuit devices.

### BACKGROUND

Continuous advances in semiconductor process technology produce devices that are smaller, faster, and more densely integrated. Large numbers of neighboring circuits switching together can produce large local current spikes, and consequent local voltage degradation. Supply-voltage degradation (i.e., supply noise) impacts the drive capability of transistors, and may consequently introduce logic failures and otherwise hamper circuit function. Degradation of reference voltages can likewise introduce errors.

Decoupling capacitors, also called “bypass” capacitors” or “filter capacitors,” are commonly coupled to sensitive DC nodes to dampen noise. Unfortunately, bypass capacitors can themselves couple noise from one circuit block to the next. Also disadvantageous, bypass capacitors, when integrated, occupy valuable die area, up to twenty percent of the total area in some high-speed circuits. Finally, integrated bypass capacitors tend to leak current and thus waste power. These problems are growing more troublesome as improved integrated-circuit (IC) processes allow for higher speeds and thinner dielectrics.

FIG. 1 (prior art) depicts a conventional IC die 100 with two circuit blocks 105 and 110. In this simple example, circuit block 105 includes a pair of transmitters 115 and circuit block 110 a pair of receivers 120. Transmitters 115 each include a supply terminal connected to a power-supply node Vdd1. Local bypass capacitors 125 provide about one-third of the requisite decoupling capacitance, while a shared bypass capacitor 130 provides the remaining two-thirds. Capacitors 125 are connected to their respective transmitters using relatively low-impedance connections, while capacitor 130, the so-called “far-field” bypass capacitor, exhibits sufficient connection impedance to exhibit a desired damping effect, typically less then ten ohms. Each of receivers 120 includes a supply terminal connected to a second power-supply node Vdd2. Receivers 120 are provided with respective local and far-field bypass capacitors 135 and 140 similar to those of block 105.

If circuit blocks 105 and 110 are never simultaneously active and voltage nodes Vdd1 and Vdd2 source the same supply voltage, blocks 105 and 110 might share one of far-field bypass capacitors 130 and 140 to save area. Such sharing may not be an option, however, as voltages Vdd1 and Vdd2 may be different, or the blocks may be sensitive to noise coupled by the shared bypass capacitor from other active blocks. For example, block 105 may be one of a plurality of blocks associated with node Vdd1, and the other blocks on node Vdd1 may impart noise onto node Vdd1 even when transmitters 115 are inactive.

### BRIEF DESCRIPTION OF THE DRAWINGS

The subject matter disclosed herein is illustrated by way of example, and not by way of limitation, in the figures of the accompanying drawings and in which like reference numerals refer to similar elements and in which:

FIG. 1 (prior art) depicts a conventional integrated-circuit (IC) die 100, including two circuit blocks 105 and 110 with integrated bypass capacitors.

FIG. 2 is an integrated-circuit (IC) die 200 in which first and second circuit blocks 205 and 210 switchably couple to a bypass capacitor circuit 215 in accordance with one embodiment.

FIG. 3 depicts an integrated circuit 300 that includes a pair of pseudo-differential receivers 305 and 310 and a configurable bypass capacitor circuit 315 in accordance with another embodiment.

FIG. 4 depicts a die 400 in accordance with another embodiment.

FIG. 5 depicts an integrated circuit 500 that includes a transmitter 505 and receiver 510, two exemplary circuit blocks that share a configurable bypass capacitor circuit 515 in accordance with yet another embodiment.

FIG. 6 is a flowchart 600 describing the operation of the circuitry of FIG. 5 in accordance with an embodiment in which a bypass capacitance is shared between nodes supplying disparate voltages.

### DETAILED DESCRIPTION

FIG. 2 is an integrated-circuit (IC) die 200 in which first and second circuit blocks 205 and 210 time-share a bypass capacitor circuit 215 in accordance with one embodiment. Circuit block 205 includes a plurality of transmitters 220 in this example. Each transmitter 220 includes a supply terminal coupled to ground via a corresponding local bypass capacitor 225. The supply terminals are additionally coupled to a first direct-current voltage (DCV) node Vdd1, a supply terminal. Circuit block 210 includes a pair of receivers 230, each including a supply terminal coupled to ground potential via a local bypass capacitor 235 and to a second DCV node Vdd2. In this embodiment, transmitters 220 and receivers 230 are active at different times, and can consequently share bypass capacitor circuit 215 on a time-multiplexed basis. This sharing eliminates the need for two separate far-field bypass capacitors, and thus saves valuable die area.

Bypass capacitor circuit 215 includes a bypass capacitor 240 and a pair of switch circuits in the form of switches 245 and 250. Each switch includes a first current-handling terminal connected to one of the first and second DCV nodes Vdd1 and Vdd2, and a second current-handling terminal coupled to one terminal of bypass capacitor 240. The second terminal of capacitor 240 is coupled to ground potential, a third DCV node. For purposes of the present disclosure, a DCV node is a circuit node that maintains a relatively constant voltage over a period that is long relative to the switching speed of IC components. Common DCV node examples include nodes coupled to DC supply and reference voltages.

Switch 245 is closed and switch 250 open when transmitters 220 are active (e.g., are transmitting or are preparing to transmit). Conversely, switch 245 is open and switch 250 closed when receivers 230 are active and transmitters 220 are inactive. The active circuit block thus benefits from the increased bypass capacitance provided by shared capacitor 240: the absence of a connection from the inactive circuit block to shared bypass capacitor 240 does not typically impact circuit performance. Also important, the first and second DCV nodes Vdd1 and Vdd2 remain de-coupled from each other, so noise on the DCV node associated with the inactive circuit block may be decoupled from the DCV node of the active circuit block. This decoupling may be important when additional active circuits are coupled to the DCV node of an inactive circuit block. Due to the decoupling, the voltages supplied via nodes Vdd1 and Vdd2 may be the same or different.

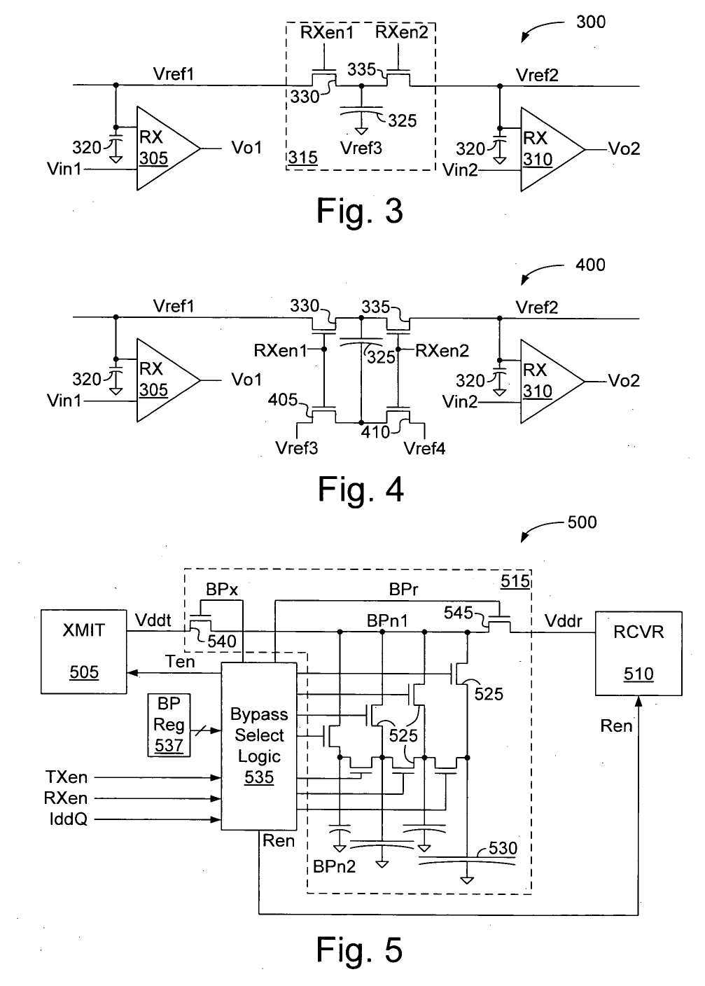

FIG. 3 depicts an integrated circuit 300 that includes a pair of pseudo-differential receivers 305 and 310 and a time-multiplexed bypass capacitor circuit 315 in accordance with another embodiment. Receiver 305 compares a first reference voltage Vref1 with an input voltage Vin1 to produce an output voltage Vo1. Receiver 310 similarly produces an output voltage Vo2 by comparing a second reference voltage Vref2 with a second input voltage Vin2. Reference voltages Vref1 and Vref2 are both DC voltages provided on like-named DCV nodes, and can be the same or different.

Each of receivers 305 and 310 has an associated local bypass capacitor 320. To save die area, receivers 305 and 310 share a time-multiplexed bypass capacitor 325 within bypass capacitor circuit 315. To facilitate this sharing, bypass capacitor circuit 315 additionally includes a pair of transistor switch circuits in the form of transistor switches 330 and 335 that may be used to couple one, both, or neither of DCV nodes Vref1 and Vref2 to a third DCV node Vref3 via capacitor 325. The third reference voltage Vref3 is ground potential in this embodiment, but other voltage levels might also be used. Transistors 330 and 335 and bypass capacitor 325 may be formed using standard MOS processes, though other types of switches and capacitors are equally suitable.

In one embodiment, the components of IC die 300 may support four operational modes. In the first mode, both transistor switches 330 and 335 are inactivated or turned off (i.e., signals RXen1 and RXen2 are de-asserted). This condition de-couples capacitor 325 from reference-voltage nodes Vref1 and Vref2. Transistors 330 and 335 can be simultaneously disabled for an instant when switching between nodes Vref1 and Vref2, such as where those nodes support different voltages, to avoid glitches on nodes Vref1 and Vref2. Moreover, capacitors are often formed using field-effect transistor structures that allow for undesirable levels of leakage current. Disabling both transistors 330 and 335 when receivers 305 and 310 are inactive reduces leakage current and consequently saves power. This functionality can be tied to an integrated circuit's power-management circuitry. Also useful, the various operational modes may be used in testing to distinguish the leakage-current contributions from various components.

In the second mode, both transistor switches 330 and 335 are activated or turned on (i.e., signals RXen1 and RXen2 are asserted). This mode may be used e.g. as an intermediate mode to stabilize the voltage on nodes Vref1 and Vref2 when switching between nodes Vref1 and Vref2. This second mode may be avoided, however, when the voltages presented on nodes Vref1 and Vref2 are dissimilar.

The final two modes supported by die 300 are receiver 305 active and receiver 310 active. When receiver 305 is active, signal RXen1 is asserted (logic one) to couple bypass capacitor 325 to node Vref1. In that case, the bypass capacitor circuit 315 filters noise on the reference terminal of receiver 305. In the final mode, signal RXen2 is asserted and signal RXen1 de-asserted, in which case the shared bypass capacitor 325 filters noise on the reference terminal of receiver 310. In the embodiments in which reference voltages Vref1 and Vref2 are the same, transistor switches 330 and 335 can both be on for an instant (i.e., in the second mode) when transitioning between receivers 305 and 310. Conversely, both transistors 330 and 335 can be turned off for an instant when transitioning between receivers 305 and 310.

FIG. 4 depicts a die 400 in accordance with another embodiment. Die 400 is similar to die 300 of FIG. 3, like-elements being the same or similar. To the circuit of FIG. 3 is added a second pair of transistors 405 and 410. These allow the DC-voltage node coupled to the lower terminal of capacitor to be alternately coupled to a third or a fourth DC-voltage node Vref3 and Vref4.

FIG. 5 depicts an integrated circuit 500 that includes a transmitter 505 and receiver 510, two exemplary circuit blocks that share a time-shared bypass capacitor circuit 515 in accordance with yet another embodiment. The value of the bypass capacitance and the resistance associated therewith are often important for high-speed applications. Unfortunately, integrated circuit parameters, including resistance and capacitance, can vary considerably with process variations. Bypass capacitor circuit 515 and associated control circuitry address this problem by allowing for post-fabrication adjustment in the values of bypass capacitance and resistance. This post-fabrication adjustment of bypass characteristics can be used with or without bypass-capacitor sharing in the manner detailed above.

Bypass capacitor circuit 515 is equipped with a collection of transistors 525 and discreet capacitors 530 that together define the resistances and capacitance between first and second bypass nodes BPn1 and BPn2. Bypass select logic 535, coupled to the gates of transistors 525, allows different ones or collections of capacitors 530 to be connected in parallel. Capacitors 530 are of different areas in this example, and consequently exhibit different levels of capacitance. In one embodiment, the areas of capacitors 530 are binary-coded to provide adjustment granularity and an adequate range of capacitive adjustment with a reasonably low number of capacitors. Other area relationships might also be used.

Transistors 525 are arranged not only to select various levels of capacitance, but also to allow for adjustments in the level of resistance provided to and from whichever of capacitors 530 are selected. Transistors 525 are controlled by bypass select logic 535, which can consequently tune the bypass capacitance and bypass resistance. Bypass capacitor circuit 515 can thus be tuned as needed by transmitter 505 and receiver 510. Once known, the appropriate settings for bypass select logic 535 can be stored in a bypass register 537. In some embodiments, one or both of the resistance and capacitance provided by bypass capacitor circuit 515 can be adjusted independently for different circuit blocks. Other embodiments employ different means for adjusting bypass capacitance, bypass resistance, or both, to provide exclusive or shared bypass characteristics for one or more components.

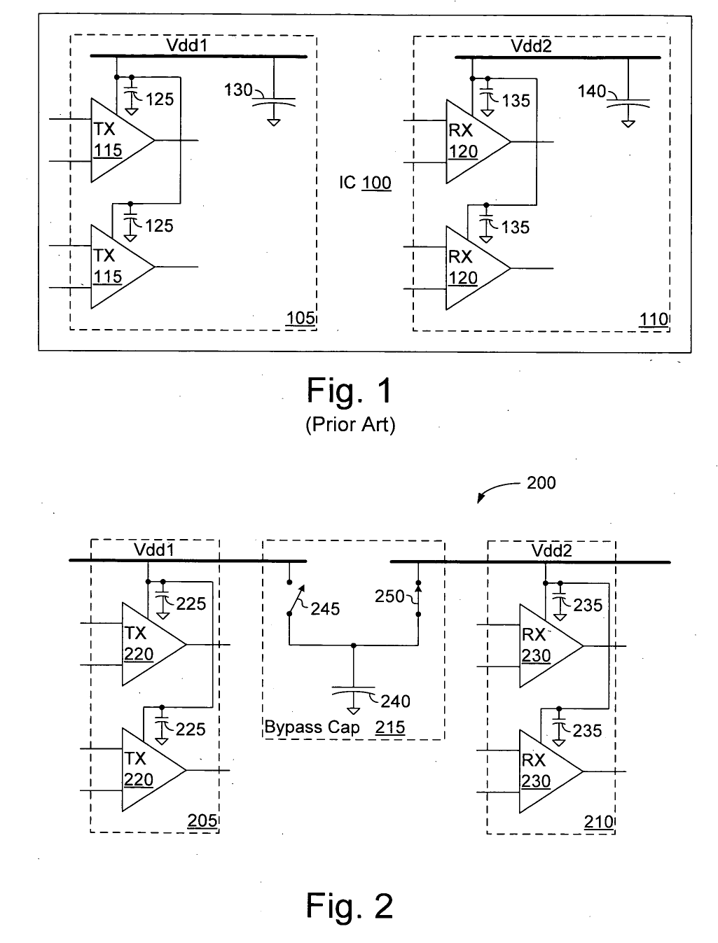

IC 500 supports sharing of bypass capacitance as discussed above in connection with the embodiments of FIGS. 1-4. A transmit-enable signal TXen alerts bypass select logic 535 that transmitter 505 is to be enabled. Bypass select logic 535 responds by turning on selected ones of transistors 525, as directed by the information in register 537, and asserting bypass-transmitter signal BPx. Supply terminal Vddt to transmitter 505 is thus coupled to DCV node BPn2 via an appropriately adjusted bypass capacitance.

A receive-enable signal RXen alerts bypass select logic 535 that receiver 510 is to be enabled. Bypass select logic responds by turning on selected ones of transistors 525, again as directed by the information in register 537, and asserting bypass-receiver signal BPr. Supply terminal Vddr to receiver 510 is thus coupled to DCV node BPn2 via an appropriately adjusted bypass capacitance. A final signal IddQ is a global signal that can be included to support a test mode in which all bypass capacitors on IC 500 are turned on simultaneously to test for leakage current. In one embodiment, asserting IddQ enables all of transistors 525 irrespective of the contents of register 537.

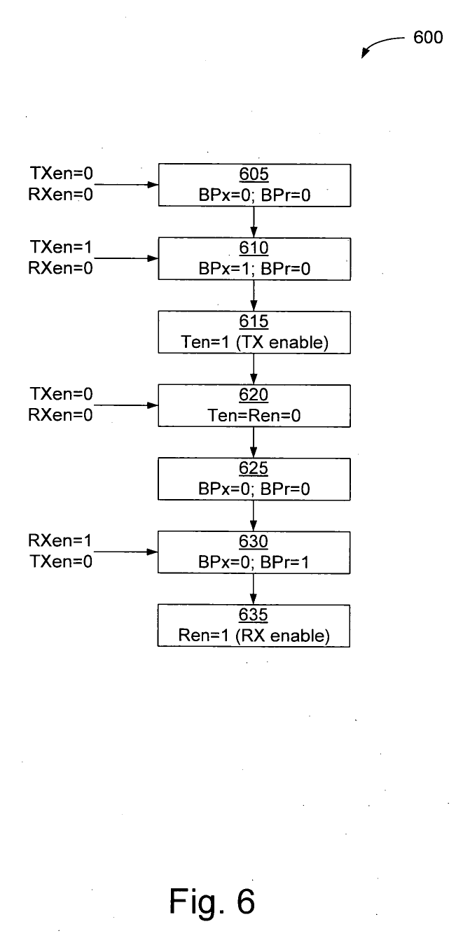

FIG. 6 is a flowchart 600 describing the operation of the circuitry of FIG. 5 in accordance with an embodiment in which a bypass capacitance may be shared between DCV nodes supplying disparate voltages. At step 605, each of signals TXen and RXen is deasserted so that transmitter 505 and receiver 510 are disabled. Next, at step 610, transmit-enable signal TXen is asserted to enable transmitter 505. In response, bypass select logic 535 first asserts signal PBx to connect transmitter 505 to selected ones of capacitors 530 via selected transistors 525. Bypass select logic 535 tailors the capacitance of the bypass capacitor circuit 515 for transmitter 505 based on previously stored settings in register 537. Then, after voltage Vddt has had an opportunity to settle, bypass select logic 535 enables transmitter 505 by asserting signal Ten (step 615). Transmitter 505 is then able to transmit information.

Once finished transmitting, transmit-enable signal TXen may be deasserted to disable transmitter 505 for power savings or to prepare for enabling receiver 510. Select logic 535 then deasserts signal Ten to disable transmitter 505 (step 620). Next, in step 625, select logic 535 opens the connection to transmitter 505 prior to closing the connection to receiver 510 by deasserting signals BPx and BPr. In other embodiments, such as where voltages Vddt and Vddr are equal, select logic 537 can activate both transistors 540 and 545 simultaneously for an instant in switching between circuit blocks. Such a “make-before-break” approach may advantageously reduce noise spikes on terminals Vddt and Vddr.

Receive-enable signal RXen is asserted to enable receiver 510. Select logic 535 responds by asserting signal BPr (step 630) to couple voltage node Vddr to selected bypass capacitors 530. Bypass select logic 535 tailors the capacitance of the bypass capacitor circuit 515 for receiver 510 based on previously stored settings in register 537, which may be the same or different from the settings for transmitter 505. Then, after voltage Vddr has had an opportunity to settle, bypass select logic 535 enables receiver 510 by asserting signal Ren (step 635).

An output of a process for designing an integrated circuit, or a portion of an integrated circuit, comprising one or more of the circuits described herein may be a computer-readable medium such as, for example, a magnetic tape or an optical or magnetic disk. The computer-readable medium may be encoded with data structures or other information describing circuitry that may be physically instantiated as an integrated circuit or a portion of an integrated circuit. Although various formats may be used for such encoding, these data structures are commonly written in Caltech Intermediate Format (CIF), Calma GDS II Stream Format (GDSII), or Electronic Design Interchange Format (EDIF). Those of skill in the art of integrated circuit design can develop such data structures from schematic diagrams of the type detailed above and the corresponding descriptions and encode the data structures on computer readable medium. Those of skill in the art of integrated circuit fabrication can use such encoded data to fabricate integrated circuits comprising one or more of the circuits described herein.

While the present invention has been described in connection with specific embodiments, variations of these embodiments will be obvious to those of ordinary skill in the art. For example, a shared external capacitor could be used instead of or to supplement integrated bypass capacitors. Such an embodiment may reduce the number of pins required to provide external capacitors for multiple circuits. Moreover, some components are shown directly connected to one another while others are shown connected via intermediate components. In each instance the method of interconnection, or “coupling,” establishes some desired electrical communication between two or more circuit nodes, or terminals. Such coupling may often be accomplished using a number of circuit configurations, as will be understood by those of skill in the art. Therefore, the spirit and scope of the appended claims should not be limited to the foregoing description. Only those claims specifically reciting “means for” or “step for” should be construed in the manner required under the sixth paragraph of 35 U.S.C. Section 112.

What is claimed is:

1. An integrated-circuit die comprising:
a. first, second, and third DC-voltage nodes;
b. a first circuit connected to the first DC-voltage node;
c. a second circuit connected to the second DC-voltage node;
d. a bypass capacitor circuit having a first capacitor terminal and a second capacitor terminal, wherein the first capacitor terminal is selectively coupled to the first and second circuits, and the second capacitor terminal is coupled to the third DC-voltage node.

2. The integrated-circuit die of claim 1, wherein the bypass capacitor circuit comprises:
a. a bypass capacitor;
b. a first switch circuit having first and second current-handling terminals, the first switch circuit coupled to the bypass capacitor to form a first series path between the first and third DC-voltage nodes; and
c. a second switch circuit having third and fourth current-handling terminals, the second switch circuit coupled to the bypass capacitor to form a second series path between the second and third DC-voltage nodes.

3. The integrated-circuit die of claim 1, wherein the first and second DC-voltage nodes are coupled to a power supply.

4. The integrated-circuit die of claim 3, wherein the power supply provides at least one supply voltage to the first and second DC-voltage nodes.

5. The integrated-circuit die of claim 1, wherein at least one of the first and second DC-voltage nodes is coupled to a reference voltage.

6. The integrated-circuit die of claim 5, wherein at least one of the first and second circuits comprises a receiver having a reference-voltage terminal connected to the respective one of the first and second DC-voltage nodes.

7. The integrated-circuit die of claim 1, wherein the bypass capacitor circuit includes: a plurality of discrete capacitors coupled in parallel between the first and second capacitor terminals; and a third switch circuit having fifth and sixth current-handling terminals coupled in series with one of the discrete capacitors.

8. The integrated-circuit die of claim 7, wherein the discrete capacitors exhibit different levels of capacitance.

9. The integrated-circuit die of claim 2, wherein the first switch circuit includes a first control terminal and the second switch circuit includes a second control terminal, the die further comprising bypass select logic coupled to the first and second control terminals to selectively activate the first and second switch circuits.

10. An integrated circuit comprising:
a. first and second DC-voltage nodes;
b. a bypass capacitor circuit having:
i. a first bypass terminal coupled to the first DC-voltage node;
ii. a second bypass terminal coupled to the second DC-voltage node;
iii. a first transistor having a first current-handling terminal coupled to the first bypass terminal, a second current-handling terminal, and a first control terminal;
iv. a second transistor having a third current-handling terminal coupled to the first bypass terminal, a fourth current-handling terminal, and a second control terminal;
v. a first discrete capacitor coupled in series between the second current-handling terminal of the first transistor and the second bypass terminal;
vi. a second discrete capacitor coupled in series between the fourth current-handling terminal of the second transistor and the second bypass terminal;
c. bypass select logic having first and second select terminals coupled respectively to the first and second control terminals of the first and second transistors.

11. The integrated circuit of claim 10, further comprising a register coupled to the bypass select logic, the register to store select data for activating at least one of the first and second transistors.

12. The integrated circuit of claim 10, wherein the bypass select logic selectively decouples the first and second discrete capacitors from the first DC-voltage node.

13. A method of sharing a bypass capacitor circuit between first and second receivers, the method comprising:
a. providing a first reference voltage to a first reference node of the first receiver;
b. coupling the first reference node to a third reference node via a bypass capacitor circuit;
c. comparing, with the first receiver, a first incoming signal with the first reference voltage;
d. decoupling the first reference node from the third reference node via the bypass capacitor circuit;
e. providing a second reference voltage to a second reference node of the second receiver;
f. coupling the second reference node to the third reference node via the bypass capacitor circuit; and
g. comparing, with the second receiver, a second incoming signal with the second reference voltage.

14. The method of claim 13, further comprising enabling the second receiver after comparing with the first receiver and before comparing with the second receiver.

15. The method of claim 13, further comprising decoupling the first and second reference nodes from the third reference node via the bypass capacitor circuit.

16. The method of claim 13, wherein the first and second reference voltages are equal, the method further comprising coupling the second reference node to the third reference node before decoupling the first reference node from the third reference node.

17. The method of claim 13, wherein the first reference voltage is different from the second reference voltage, the method further comprising coupling the second reference node to the third reference node after decoupling the first reference node from the third reference node.

18. A computer-readable medium having stored thereon a data structure defining a configurable bypass capacitor circuit for an integrated circuit, the data structure comprising:
a. first data representing first and second DC-voltage nodes;
b. second data representing first and second circuits coupled to the first and second DC-voltage nodes, respectively; and
c. third data representing a bypass capacitor circuit selectively coupled to the first and second DC-voltage nodes.

19. An integrated circuit comprising:
a. first, second, and third DC-voltage nodes;
b. a first circuit connected to the first DC-voltage node;
c. a second circuit connected to the second DC-voltage node;
d. a bypass capacitor circuit having a first capacitance terminal and a second capacitance terminal connected to the third DC-voltage node, the bypass capacitor circuit including means for selectively connecting the first capacitance terminal to one of the first and second DC-voltage nodes.

20. The integrated circuit of claim 19, wherein the bypass capacitor circuit exhibits a range of capacitance values, the integrated circuit further comprising means for selecting one of the range of capacitance values.

21. The integrated circuit of claim 20, further comprising means for selecting the one of the range of capacitance values for the first circuit and selecting a second one of the range of capacitance values for the second circuit.

22. An integrated-circuit die comprising:
a. first and second DC supply-voltage nodes;
b. a communication circuit connected to the first and second DC supply-voltage nodes;
c. a bypass capacitor circuit connected between the first and second DC supply-voltage nodes, the capacitor circuit having connected in series between the first and second supply-voltage nodes, a bypass capacitor and a variable bypass resistor; and
d. select logic adapted to control resistance through the variable bypass resistor.

23. The integrated-circuit die of claim 22, wherein the bypass capacitor exhibits a variable capacitance, and wherein the select logic is adapted to control the capacitance.

24. The integrated-circuit die of claim 22, wherein the bypass capacitor circuit further includes, in series with the bypass capacitor, a switch to selectively decouple the bypass capacitor from the communication circuit.

25. The integrated-circuit die of claim 22, wherein the communication circuit comprises at least one of a transmitter and a receiver.

26. The integrated-circuit die of claim 22, further comprising a second circuit connected to the first and second DC supply-voltage nodes and selectively connected to the bypass capacitor.

27. The integrated-circuit die of claim 26, wherein the second circuits is selectively connected to the bypass capacitor via the variable bypass resistor.
